(19) United States
(12) Patent Application Publication
(10) Pub. No.: US 2008/0094240 A1
(43) Pub. Date: Apr. 24, 2008

(54) Apparatus for monitoring the approach of two relatively movable parts

(75) Inventor: Christoph HABERER, Freiburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/974,476

(22) Filed: Oct. 12, 2007

(30) Foreign Application Priority Data
Oct. 14, 2006 (DE) 20 2006 015 768.9

(51) Int. Cl. G08B 21/00

(52) U.S. Cl. 340/686.1

(57) ABSTRACT

An arrangement for monitoring first and second relatively movable parts in which an actuator is connected to one of the first and second parts. The actuator includes a transponder. A sensor is connected to the other one of the two parts and has a receiver circuit with a receiver coil. A reduction coil is arranged so that its magnetic field can reduce a magnetic field of the receiver coil in a predetermined manner. The transponder touchlessly transmits a bit-coded transponder signal to the sensor when a distance between the actuator and the sensor falls below a predetermined value, and the receiver circuit compares the transponder signal to a stored bit sample for generating a monitoring output signal.

### RELATED APPLICATIONS

This application claims the priority of German patent application No. 20 2006 015 768.9 filed Oct. 14, 2006, which is incorporated herein by reference in its entirety.

### BACKGROUND OF THE INVENTION

This invention relates to monitoring the approach of two parts which are movable relative to each other with a sensor connected to one of the movable parts and an actuator including a transponder connected to the other movable part.

It is known to monitor the closed position of a protective system, which, for example, surrounds a dangerous machine or installation for deactivating the machine or installation when the protective system is opened, thereby providing access to the machine or installation. European patent document No. EP 0 968 567 B1 and German patent document No. DE 103 34 653 B4 disclose to install an actuator on one of the parts of the protective systems, for example a movable door, and to install a sensor on the other part, for example a fixed frame for the door. The actuator includes a transponder, and the sensor has an associated receiver circuit. When the transponder is sufficiently close to the sensor in the closed position, the transponder is activated and emits a bit-coded transponder signal. This signal is received by the sensor, which compares the signal with a bit sample stored in the receiver circuit of the sensor. When the transponder signal corresponds to the stored bit sample, the protective system is closed and the machine or installation can be permitted to operate.

For enhanced safety, the protective system disclosed in EP 0 968 566 B1 doubles the processing and evaluation of the received transponder signal in the receiver circuit to provide a redundant control. DE 103 34 653 B4 teaches to provide an additional testing feature which interrupts the receiver circuit in a predetermined manner in order to simulate the opening of the protective system from its closed position and to thereby test the responsiveness of the security arrangement. These known security arrangement improvements increase their technological complexity and therewith their cost, which is quite disadvantageous, particularly when single-chip or ASIC configurations are used.

The testing element which interrupts the receiver circuit in a predetermined manner can only test the functioning of the evaluation unit in the receiver circuit, but not the receiver element itself, including in particular the receiver coil thereof. As a result, the danger exists that a defect in the receiver will not be detected, which in turn compromises the safety of the protective arrangement.

### BRIEF SUMMARY OF THE INVENTION

It is therefore an object of the present invention to provide a protective arrangement for monitoring the approach of two parts which are movable relative to each other and which is capable of controlling the receiver itself, which, for example, can be configured as a receiver coil. The present invention thereby improves the reliability of the arrangement without increasing its technological complexity while keeping its costs low.

In brief, this is attained by providing the sensor of the security arrangement with a reduction coil that is arranged so that its magnetic field weakens the magnetic field of the receiver coil in a predetermined manner.

Thus, the security arrangement of the present invention monitors the approach of two relatively movable parts and includes a sensor with a reduction coil that is arranged so that its magnetic field weakens the magnetic field of the receiver coil. For testing the functioning of the receiver coil, the reduction coil is activated, for example at predetermined time intervals, to cyclically weaken the magnetic field of the receiver coil and thereby cyclically interrupt the energy supply for the transponder. This weakens or completely eliminates the received signal. When in such a test the signal from the transponder is interrupted, the correct functioning of the sensor and in particular the functioning of the receiver coil can be checked. Thus, the testing of the security arrangement of the present invention is not limited to only testing the evaluation unit of the sensor, but checks the proper functioning of the receiver unit itself, namely the receiver coil.

To weaken the magnetic field of the receiver coil with the magnetic field of the reduction coil, it is preferred that the phases of the receiver coil and the reduction coil are opposite each other.

In a particularly advantageous embodiment of the present invention, the strength of the magnetic field of the reduction coil is adjustable. This makes it possible to determine the distance of the transponder, that is, of the actuator to the sensor. In the event the magnetic field of the reduction coil is relatively strong, the magnetic field of the receiver coil is significantly weakened so that it has an only small or negligible magnetic field intensity. The field intensity of the sensor can be incrementally increased by correspondingly decreasing the strength of the magnetic field of the reduction coil. The receiver coil can detect the signal from the transponder only after the magnetic field strength of the receiver coil has reached a predetermined threshold strength. From the detected signal, the distance between the receiver coil and the transponder can be determined. The magnetic field strength of the reduction coil can be cyclically adjusted so that, for example, the reduction coil simulates the transponder when the cycles during which the reduction coil is adjusted correspond, for example, to a characteristic bit sequence of the transponder. Since the reduction coil is normally much closer to the receiver coil than the transponder, it is possible to test the correct functioning of the receiver coil with the reduction coil because the signal of the reduction coil generated in the receiver coil is significantly stronger than the signal of the more remote transponder. For testing purposes, a random bit sequence can be selected which does not correspond to the bit sequence of the transponder. This permits a testing of the deactivateability of the sensor because the random signals from the transponder are stronger than the expected bit sequence from the transponder so that the latter will not be detected by the receiver coil.

The magnetic field strength of the reduction coil can preferably be adjusted with an adjustable resistor or with an FET transistor.

An adjustable switching element is preferably provided for activating or deactivating the reduction coil in a predetermined manner. The switching element permits the activation or deactivation of the reduction coil. By properly controlling the switching element, it is possible to generate a varying signal that corresponds to a bit sequence. In a particularly preferred embodiment, the switching element is a semiconductor.

In another preferred embodiment of the present invention, the reduction coil is integrated into the receiver circuit. To effect a weakening of the magnetic field of the receiver coil with the magnetic field of the reduction coil, the two coils are electrically coupled so that current flows through them in opposite directions or the respective coils are wound in opposite directions.

In an alternative embodiment of the present invention, a voltage supply is provided for the reduction coil which is independent of the receiver circuit. This simplifies the adjustment of the magnetic field strength of the reduction coil independent of the magnetic field strength of the receiver coil.

In a particularly preferred embodiment of the present invention, the receiver coil and the reduction coil are arranged on a common magnet core which improves the coupling between the two coils. It is preferred that the magnetic core is made of ferrite.

Security arrangements made in accordance with the present invention are particularly useful for securing areas about potentially dangerous machines and installations which are surrounded by fences or barriers to limit access from persons present in their vicinity and which are provided with protective doors. The actuator of the security arrangement is preferably attached to the movable door, while the sensor of the arrangement is preferably mounted to the fixed door frame. With the arrangement of the present invention, it can be checked whether the door is in its closed or open position.

### BRIEF DESCRIPTION OF THE DRAWINGS

FIG. 1 schematically illustrates a first embodiment of the invention; and

FIG. 2 schematically illustrates a second embodiment of the invention.

### DESCRIPTION OF THE PREFERRED EMBODIMENTS

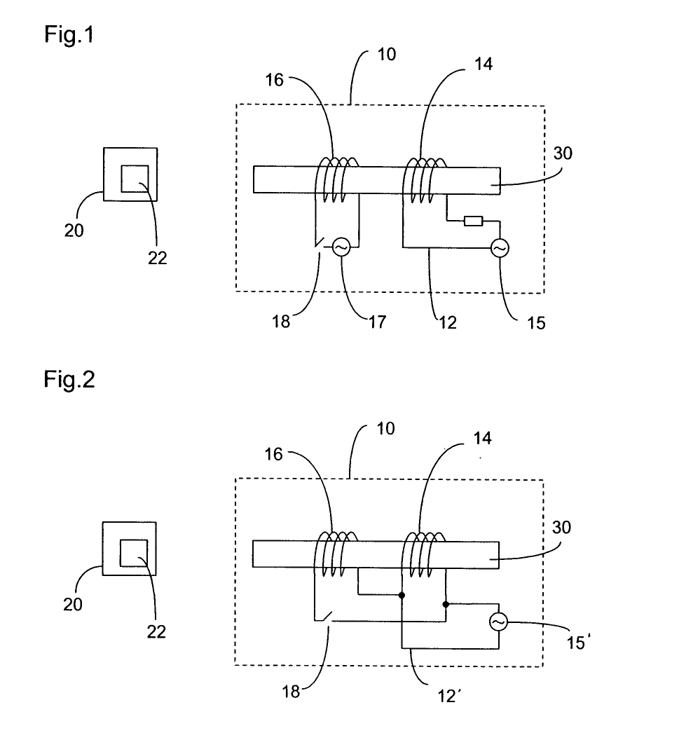

FIGS. 1 and 2 show two examples of a security arrangement made in accordance with the present invention for monitoring the approach of two parts that can move relative to each other. Like parts were given the same reference numerals. In particular, the relatively movable parts in the illustrated embodiments comprise a door (not shown in the drawings) which is pivotally attached to a fixed door frame (not shown).

The security arrangement of the present invention has a sensor 10 which is mounted on the fixed door frame, for example. The arrangement further includes an actuator 20, which is mounted separately from sensor 10, and the sensor is a touchless approach sensor. Actuator 20 can be attached to and positioned on a door, which may be pivotally or slidably movable in a fixed door frame, so that the actuator is closely positioned relative to the sensor when the door is closed and is remote from the sensor when the door is in the open position. The actuator 20 includes a transponder 22 which is preferably a passive transponder.

Referring to FIG. 1, in the first embodiment, sensor 10 includes a receiving circuit 12 with a receiver coil 14. Receiving circuit 12 has a voltage source 15 that directs an electric current through receiver coil 14 for generating a magnetic field with the receiver coil. The magnetic field of the receiver coil 14 provides energy for transponder 22 when the transponder is sufficiently close to sensor 10. When a given approach threshold is reached, the transponder transmits a bit-coded transponder signal to sensor 10. Receiver coil 14 also serves as a receiver because it detects the transponder signal and compares it to a stored bit map with an evaluation unit (not shown) that is part of the receiving circuit 12 and generates an emitted monitoring signal.

Sensor 10 includes a reduction coil 16 that cooperates with the receiver circuit 12, and in particular the receiver coil 14, to ascertain that the receiver coil functions correctly. A voltage source 17 supplies reduction coil 16 with electric current. Receiver coil 14 and reduction coil 16 are arranged on a common magnet core 16 which is preferably a ferrite core. The windings of the receiver coil 14 and reduction coil 16 are wound about magnetic core 16 in a common direction. The current must flow in opposite directions through receiver coil 14 and reduction coil 16 so that the reduction coil can generate a magnetic field which reduces the magnetic field of receiver coil 14. Reduction coil 16 additionally includes a switching element 18 for activating and deactivating the reduction coil. This permits a planned, such as a cyclical, reduction of the magnetic field of receiver coil 14 by the magnetic field of the reduction coil 16. A control (not shown) can also be provided for changing the strength of the magnetic field of the reduction coil when it is in its activated state.

The embodiment of the present invention shown in FIG. 2 differs from that shown in FIG. 1 in that the reduction coil 16 and receiver coil 14 have a common voltage source 15′. The receiver coil 14 and reduction coil 16 are arranged in a common receiving circuit 12′. The receiver coil 14 and reduction 16 are electrically parallel to each other, and a switching element 18 is provided for activating the reduction coil. Receiver coil 14 and reduction coil 16 are again arranged on a common magnetic core 30, and their windings extend in the same direction about the magnetic core. Receiver coil 14 and reduction coil 16 are electrically parallel and their respective proximate and distal ends on the core are connected to the same pole of voltage source 15′. As a result, current flows through receiving coil 14 and reduction coil 16 on magnetic core 30 in opposite directions. The magnetic field generated by reduction coil 16 weakens the magnetic field of receiver coil 14. The correctness of the coil windings and the electrical connections of the receiver coil 14 and reduction coil 16 and the resulting correct oppositely phased operation of both windings 14, 16 can be checked with an additional testing coil (not shown).

A wrong monitoring signal from sensor 10 can be checked by weakening the magnetic field of receiver coil 14 with the reduction coil 16 sufficiently to disrupt the energy supply for transponder 22 so that receiving circuit 12, 12′ cannot detect the signal from transponder 22. In the event a corresponding monitoring signal is still present, that is, when sensor 10 generates a signal in spite of the fact that reduction coil 16 reduced the magnetic field, the sensor malfunctions, which is thereby detected.

What is claimed is:

1. Apparatus for monitoring first and second relatively movable parts comprising an actuator connected to one of the first and second parts and including a transponder,
a sensor connected to the other one of the first and second parts and including a receiver circuit with a receiver coil, and a reduction coil which is arranged so that its magnetic field reduces a magnetic field of the receiver coil in a predetermined manner,
the transponder being adapted to touchlessly transmit a bit-coded transponder signal to the sensor when a distance between the actuator and the sensor falls below a predetermined value,
wherein the receiver circuit being adapted to compare the transponder signal to a stored bit sample for generating a monitoring output signal.

2. Apparatus according to claim 1 wherein the receiver coil and the reduction coil are subjected to opposing phases.

3. Apparatus according to claim 1 wherein a strength of the magnetic field of the reduction coil is adjustable.

4. Apparatus according to claim 3 wherein the strength of the magnetic field of the reduction coil is adjustable with one of an adjustable resistor and a FET transistor.

5. Apparatus according to claim 1 including a switching element for controlling the reduction coil.

6. Apparatus according to claim 5 wherein the switching element comprises a semiconductor element.

7. Apparatus according to claim 1 wherein the reduction coil is integrated into the receiver circuit.

8. Apparatus according to claim 1 including a voltage source for the reduction coil which is independent of the receiver circuit.

9. Apparatus according to claim 1 including a common magnetic core, and wherein the receiver coil and the reduction coil are arranged on the common magnet core.

10. Apparatus according to claim 1 wherein the first and second parts comprise a door and a door frame, respectively.
